(19) United States
(12) Patent Application Publication
(10) Pub. No.: US 2007/0032365 A1
(43) Pub. Date: Feb. 8, 2007

(54) Glass composition

(76) Inventors: Zsuzsanna K. Varga, Venetianer (HU); Gyorgy L. Liptak, Matyas (HU)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/197,100

(22) Filed: Aug. 4, 2005

(51) Int. Cl. C03C 3/095; C03C 3/087

(52) U.S. Cl. 501/64; 501/71

(57) ABSTRACT

A glass composition for parts of electric lamps is disclosed, which is substantially free of lead and comprises the following components in percentage by weight: SiO2 60-72 Al2O3 1-5 Li2O 0.5-1.5 Na2O 5-9 K2O 3-7 MgO 1-2 CaO 1-3 Sro 1-5 BaO 7-11 Fe2O3 0.03-0.06 Sb2O3 0.1-0.5 CeO2 0.3-0.7

### BACKGROUND OF THE INVENTION

This invention relates to a glass composition for electric lamps, and more particularly to a glass composition substantially free of lead for use in electric lamps.

Glass compositions with approx. 20% lead oxide content have been used widely in lighting industry to produce stems and exhaust tubes for different lamp families as well as envelopes for automotive and compact fluorescent lamps. Since lead oxide is a harmful pollutant, it shall be ensured that electrical and electronic equipment put on the market does not contain lead in accordance with the Directive 2002/95/EC of the European Parliament and Council.

In the last decades, oxy-fuel firings of glass melting furnaces were implemented in glass production lines of lighting industry. Gas-oxygen firing results in a firing atmosphere of high partial vapour pressure of water, which influences glass fining process.

EP Patent No. 603 933 describes a lead free glass composition for use in electric lamps as stem glass as well as envelopes for compact fluorescent lamps. CeO2 is added in an amount of up to 0.2% by weight to improve UV absorption of the glass composition. In a starting batch of the glass composition, Na₂SO₄ is used as a fining agent.

U.S. Pat. No. 5,843,856 discloses a lead free glass composition for electric lamps comprising SiO₂, Al₂O₃, Na₂O, K₂O and B₂O₃ as well as optionally Li₂O, CaO, MgO, SrO, Sb₂O₃, Fe₂O₃, MnO₂ and/or CeO₂. In addition, the glass composition contains ZnO and optionally TiO₂ and/or P₂O₅.

U.S. Pat. No. 5,843,855 describes a lead free glass composition for electric lamps, in which the glass contains only a small amount of BaO and production cost of the glass does not differ considerably from that of a traditional glass containing lead.

U.S. Pat. No. 5,885,915 describes a glass composition for electric lamps comprising neither PbO nor BaO or optionally ZnO while its characteristics determining the use for electric lamps are equivalent to or better than known compositions containing BaO.

None of the glass compositions disclosed in the patents above simultaneously fulfills all the requirements of electrically highly resistive stem glass, highly effective UV absorption up to 320 nm and stable fining and melting process with improved capability for production of good quality low cost glass even in oxy-fuel fired furnaces.

There is a particular need for developing an economic lead free glass composition with more effective UV absorption and produced by oxy-fuel fired furnaces for stems and envelopes of electric lamps and even for envelopes of compact fluorescent lamps that include bulky plastic parts or fit into plastic fixtures.

### SUMMARY OF THE INVENTION

In an exemplary embodiment of the invention, a glass composition is provided for parts of electric lamps that is substantially free of PbO and comprises components in percentage by weight as follows:

| | |
|---|---|
| SiO₂ | 60-72 |
| Al₂O₃ | 1-5 |
| Li₂O | 0.5-1.5 |
| Na₂O | 5-9 |
| K₂O | 3-7 |
| MgO | 1-2 |
| CaO | 1-3 |
| SrO | 1-5 |
| BaO | 7-11 |
| Fe₂O₃ | 0.03-0.06 |
| Sb₂O₃ | 0.1-0.5 |
| CeO₂ | 0.3-0.7 |

The use of this glass composition has substantial advantages over the prior art. The glass material of this composition has an excellent UV absorption, which also meets the requirements of compact fluorescent lamps with plastic fixtures. Melting, fining and shaping processes are better controlled. This glass composition can replace the lead containing glass materials used widely in all area of lamp production.

### BRIEF DESCRIPTION OF DRAWINGS

The invention will now be described with reference to enclosed drawings where:

FIG. 1 shows a graph of UV absorption curves varying with the quantity of CeO₂ content in the glass,

FIG. 2 shows a graph of the area fraction of bubbles in the glass melt during melting process,

FIG. 3 shows a view of a compact fluorescent lamp with bulky plastic parts, and

FIG. 4 shows a schematic view of a stem for an electric lamp.

### DETAILED DESCRIPTION OF THE INVENTION

The glass material made of the proposed lead free glass composition fulfills the requirement of improved UV absorption of envelopes of compact fluorescent lamps that have bulky plastic parts and fit into plastic fixtures. Due to technical parameters of this glass material, it can be used in all area of lamp production lines instead of lead containing glass material. Fining package composed for the production of this glass material makes the production process more economical and better controlled.

UV absorption properties of a glass composition can be improved by addition of selected components, which have absorption band in the UV range of the light. For example, iron in oxidized form has an absorption peak in UV range up to 400 nm, though absorption coefficient of this component is relatively low. Higher quantity of iron would be necessary to accomplish the required UV absorbing effect, however light transmittance in the visible range is also significantly influenced in that case, and remarkable lumen loss and colour change of the lamp appear.

Inclusion of rare earth elements, primarily cerium, has effective UV absorption in the required region without significantly influencing the light transmittance in the visible range. The UV absorption increases with increasing quantity of cerium, however absorption properties are also influenced by other glass components and the redox state of the glass.

Glass compositions were melted with different fining packages in laboratory and UV light transmittance was tested. It was found that 0.33% by weight of CeO₂ addition resulted in UV light transmittance of 1.06% at 285 nm in a glass composition with sodium sulphate, while light transmittance was 0.55% at the same wavelength in a glass composition with 0.33% by weight of CeO₂ together with antimony and nitrate. The glass was more oxidized with a fining package of antimony and nitrate. These data show that in order to accomplish improved UV absorption, it is more preferable to keep the glass in oxidized state than in reduced one.

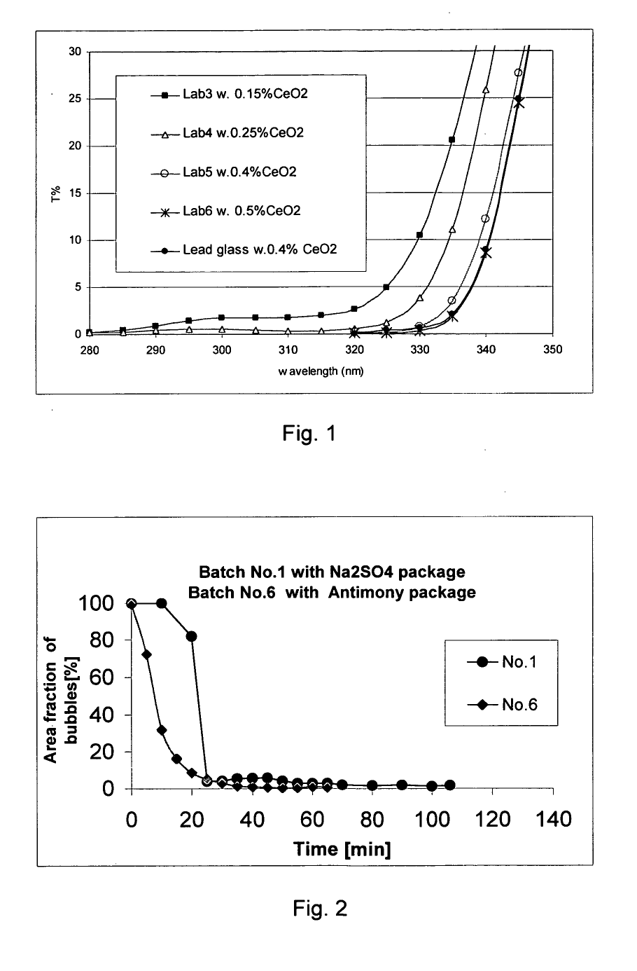

UV absorption curves varying with the quantity of CeO₂ content can be seen in FIG. 1. The transmittance ratio (T %) of lead free glass compositions with different CeO₂ content and leaded glass material with 0.4% by weight of CeO₂ content were measured and plotted as a function of wavelength in nanometers. To find optimum quantity of the UV absorbing component, glass compositions with different cerium-oxide contents were melted and the UV light transmittances of samples were tested. A fining package with antimony and nitrate was used. It was found by the tests that 0.5% by weight CeO₂ in a lead free glass composition provided the same absorption effect as 0.4% by weight of CeO₂ content in lead containing glass with full cut off of UV light up to 320 nm. The reason for the fact that higher quantity of CeO₂ is needed into lead free glass composition can originate from an interaction between the glass matrix and the UV absorbing components of the glass and the possible changing of redox during melting. In a further embodiment of the invention, CeO₂ in an amount of 0.4-0.6% by weight is used in order to accomplish the UV cut off at 320 nm.

The fining process of the glass depends on solubility and diffusion of gases in the melt, which are basically determined by nature of the gases, partial pressure of the gases, basicity, surface tension of the glass melt and temperatures used. Fining agents have to be selected taking these factors into account. Chemically bonded gas components of raw materials and air between grains of raw materials result in gas bubbles in the glass melt. These gaseous inclusions must be removed during the fining process and fining agents are added to the glass melt in order to support elimination of gas bubbles. The fining agents have the function of producing fining gases that will diffuse into the gas bubbles resulting in growth of these bubbles and consequent ascending and release of them.

The fining agents used mostly in glass industry are sodium sulphate and antimony trioxide. Potassium or sodium nitrate is added to ensure that antimony is dissolved in the melt in the form of Sb₂O₅. Sb₂O₅ is an effective fining agent and makes the glass to be sufficiently oxidized. In a further embodiment of the invention, the glass composition, in which CeO₂ in an amount of 0.4-0.6% by weight is used, also comprises Sb₂O₃ in an amount of 0.2-0.4% by weight. Sodium sulphate is less suitable as a fining agent in glasses, which have to be melted under strongly oxidizing conditions. The released gases in high barium content glass compositions with sulphate fining cause formation of high viscous foam in conditions of oxy-fuel melting.

Laboratory tests were made on batch samples with different fining packages in a specially designed high temperature observation furnace. In FIG. 2, the area fraction variation of bubbles during the melting process is plotted as a function of time. Experimental conditions of laboratory furnace were set according to the atmosphere of oxy-fuel furnaces. Following the fining process, we monitored the number and growth of the bubbles in the melt after the melting temperature was reached. Batch compositions with antimony showed quick release of the bubbles. In these compositions, proportion of the antimony to the nitrate was selected from the range of 1-5 parts Sb₂O₃ to 10-20 parts KNO₃ in a glass unit of 1000 parts and the ratio of KNO₃/Sb₂O₃ was in the domain of 4-8. Rate of cullet during the tests was in the range of 0-40%.

In spite of using antimony and nitrate as fining agents, in the event that a batch contained sulphate, dense foam was observed at the beginning of a melting process and a longer time was required to reach the bubble free state.

### EXAMPLE

Industrial test was made with natural gas and oxygen furnace in a continuous working glass production line. Glass was melted from a batch of usual glass raw materials and cullet. The batch consisted of quartz sand, soda ash, potash ash, lithium feldspar, dolomite, barium carbonate, strontium carbonate, lithium carbonate, fining agents of antimony oxide and potassium nitrate. Cerium-oxide was added as UV absorbing dope material. The batch and the cullet were charged continuously by a screw charger. The resulted glass composition by chemical analysis was in weight percentage as follows:

| | |
|---|---|
| SiO₂ (%) | 68 |
| Na₂O (%) | 7.3 |
| K₂O (%) | 4.8 |
| Li₂O (%) | 1.1 |
| BaO (%) | 8.5 |
| SrO (%) | 3 |
| CaO (%) | 1.9 |
| MgO (%) | 1.3 |
| Al₂O₃ (%) | 3.3 |
| Fe₂O₃ (%) | 0.04 |
| CeO₂ (%) | 0.42 |
| Sb₂O₃ (%) | 0.20 |

The temperature of the furnace was controlled between 1400 and 1470° C. Melting and fining processes were stable with controllable batch blanket flow. Any unacceptable foaming was not experienced.

Tested physical properties

| | |
|---|---|
| Thermal expansion coefficient α_{(50-350),} (1/C.) | 96.4*10⁻⁷ |
| Glass transition temperature, Tg (C.) | 478 |
| Softening point (Littleton) T_{L}(C.) | 670 |
| Temperature at the viscosity of 10⁴dPas, Tw(C.) | 1014 |
| Density, d (g/cm³) | 2.621 |
| DC electric resistivity Tk₁₀₀ (C.) | 288 |
| UV light transmittance at λ = 300 nm for 1 mm | 0 |
| wall thickness (%) | |
| UV light transmittance at λ = 320 nm for 1 mm | 0.01 |
| wall thickness (%) | |
| UV light transmittance at λ = 340 nm for 1 mm | 8.4 |
| wall thickness (%) | |

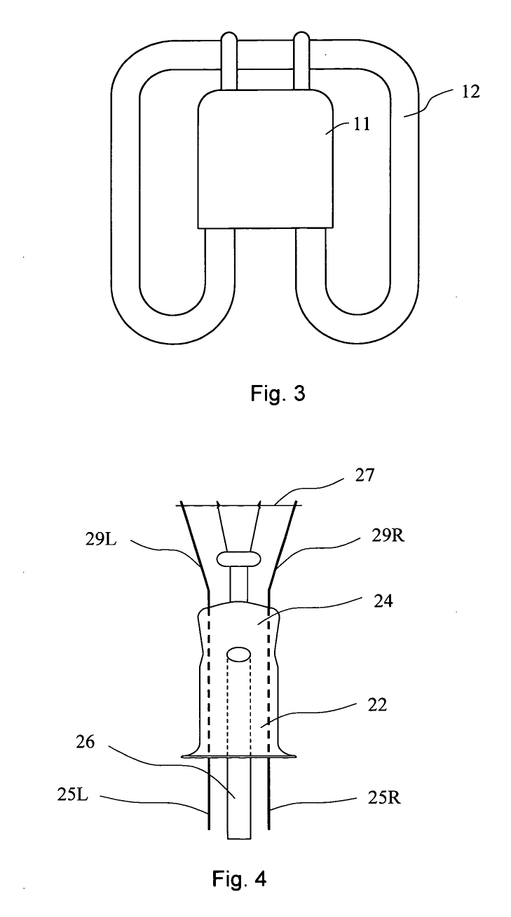

In FIG. 3, a compact fluorescent lamp of 2D form is shown. The lamp has an envelope 12 and a plastic base part 11. The envelope of the lamp was made of a glass material originated from the industrial test above. The UV absorption of the envelope 12 was at least equal to that of an envelope made of lead containing glass composition used widely. It is envisaged that the plastic base part 11 and the plastic fixture receiving the lamp will not be adversely affected by the UV radiation of the envelope 12 made of the proposed glass compared with an envelope of lead glass, that is significant discoloration will not occur before the end of life of the lamp.

In FIG. 4, a stem of an incandescent lamp is shown. The stem was made of the above glass material. The stem consists of a flare 22, lead in wires 25L, 25R, a filament 27 and an exhaust tube 26. The filament 27 is clamped to upper portions 29L, 29R of lead in wires. During the production process, the flare 22 is heated and the exhaust tube 26 and the flare 22 are melted together and an aperture in the exhaust tube 26 is blown out. An inner end 24 of the flare 22 is sealed to the upper portions 29L, 29R of lead in wires by pinching. The glass composition originated from the industrial test described above fulfills all of the requirements concerning technological steps of melting, tube drawing, shaping, aperture blowing and pinching. The sealing was sufficient so that no air leakage appeared.

1. A glass composition for parts of electric lamps, the composition being substantially free of PbO and comprising the following components in percentage by weight:

| | |
|---|---|
| SiO2 | 60-72 |
| Al2O3 | 1-5 |
| Li2O | 0.5-1.5 |
| Na2O | 5-9 |
| K2O | 3-7 |
| MgO | 1-2 |
| CaO | 1-3 |
| SrO | 1-5 |
| BaO | 7-11 |
| Fe2O3 | 0.03-0.06 |
| Sb2O3 | 0.1-0.5 |
| CeO2 | 0.3-0.7 |

2. The glass composition of claim 1 for envelopes and stems of electric lamps, having UV absorption up to 320 nm by addition of CeO₂ in an amount of 0.4-0.6% by weight.

3. The glass composition of claim 1 comprising CeO₂ in an amount of 0.4-0.6% by weight and Sb₂O₃ in an amount of 0.2-0.4% by weight.
